(19) United States
(12) Patent Application Publication
(10) Pub. No.: US 2024/0054462 A1
(43) Pub. Date: Feb. 15, 2024

(54) SYSTEMS AND METHODS FOR SUBMISSION AND PROCESSING OF REQUESTS FOR PAYMENT MESSAGES

(71) Applicant: VOCALINK LIMITED, London (GB)

(72) Inventors: Genices Batista Inoa, New York, NY (US); Sridhar Ramalingam, Wildwood, MO (US); Arundhati Chandrasekhar, Stamford, CT (US)

(21) Appl. No.: 17/819,924

(22) Filed: Aug. 15, 2022

(51) Int. Cl. G06Q 20/10; G06Q 20/02; G06Q 20/08

(52) U.S. Cl. CPC G06Q 20/102; G06Q 20/027; G06Q 20/085

(57) ABSTRACT

A billing management system providing for the submission and processing of request for payment messages, which includes a bill pay exchange (BPX) computing system having at least one processor, a database in electronic communication with the BPX computing system, the database storing data on consumers and billers that subscribed to the BPX computing system, one or more biller service providers, each of the biller service providers associated with one or more of the billers, a plurality of commercial financial institutions, each of the commercial financial institutions associated with one or more of the consumers, and a payment processing network electronically connecting the BPX computing system, the one or more biller service providers, and the plurality of commercial financial institutions.

### BACKGROUND

### Field of the Invention

This application relates to systems and methods for the submission and processing of requests for payment messages and, more specifically, to the implementation of a bill payment exchange within a billing management system that provides for the submission of requests for payment invoices by one or more billers and the retrieval of previously submitted request for payment invoices by one or more issuer banks.

### Related Art

This disclosure relates to the field of electronic bill management and, more specifically, to an electronic bill management system with a bill pay exchange system that functions as a message gateway between one or more billers and their corresponding biller service providers and a plurality of issuer banks and their corresponding consumer financial institutions.

Conventionally, consumers must navigate to a biller's online payment platform to pay each individual bill, assuming the biller provides such a service. In some cases, billers may not even provide such services through an online payment platform. Where a consumer has received three bills from three respective billers, the consumer must navigate to three separate websites (or online payment platforms) and complete three disparate bill-payment processes. Each process may require the consumer to re-enter their payment credentials.

A biller's online payment platform may be provided and maintained by a biller service provider, which provides the interface through which the consumer enters their payment credentials. The biller service provider uses the consumer's payment credentials and the biller's credentials to initiate a transaction on behalf of the biller. Each biller payment platform may have varying levels of security and may transmit or store the consumer's payment credentials. Consequently, the consumer's payment credentials may be vulnerable at various sources associated with each of the three billers due to a data breach at any of the billers or biller service providers.

A consumer may also pay bills through a payment platform associated with their bank, often referred to as a consumer financial institution. These consumer financial institutions may allow consumers to pay bills directly through their bank accounts. Once consumers have provided their account credentials to the consumer financial institutions, they may initiate a bill pay transaction against the biller's bank account.

Whether payments are provided through a biller service provider or a consumer financial institution, it is difficult to access from a centralized location

What is needed is a billing management system that provides for the submission of requests for payment from one or more billers to a centralized destination that ensures that each request for payment is routed to the proper consumer. What is also needed is a billing management system that further provides for secure access and retrieval of requests for payment invoices by a consumer across one or more registered consumer financial institutions, and that provides a current payment history for each invoice to each of the multiple registered consumer financial institutions.

### SUMMARY OF THE INVENTION

In one embodiment, a billing management system is provided for the submission and processing of request for payment messages. The system comprises a bill pay exchange (BPX) computing system comprising at least one processor, a database storing data on consumers and billers subscribing to the BPX computing system, the database in electronic communication with the BPX computing system, one or more biller service providers, each of the biller service providers associated with one or more of the billers, a plurality of commercial financial institutions, each of the commercial financial institutions associated with one or more of the consumers, the BPX computing system providing an electronic communications path between the one or more biller service providers and the plurality of commercial financial institutions. The BPX computing system is configured to receive a request to link message from a specific biller, the request to link message including a consumer proxy identifying a specific consumer and data on the specific biller, confirm the identity of the specific biller based on the data on the specific biller, confirm the identity of the specific consumer based on the consumer proxy, generate a link token based on the request to link message, the link token defining a direct linkage between the biller and the specific consumer as defined by the request to link message, store the link token in the database, and transmit the link token to the specific biller.

In another embodiment, a billing management system is provided for the submission and processing of request for payment messages. The system comprises a bill pay exchange (BPX) computing system comprising at least one processor and at least one token processor, a database storing and retrieving data on consumers and data on billers subscribing to the billing management system, the database in electronic communication with the BPX computing system, one or more biller service providers, each of the biller service providers associated with one or more of the billers, a plurality of commercial financial institutions, each of the commercial financial institutions associated with one or more of the consumers, and the BPX computing system providing an electronic communications path between the one or more biller service providers and the plurality of commercial financial institutions. The BPX computing system is configured to receive a request to link message from a specific biller, the request to link message including a consumer proxy identifying a specific consumer and data on the specific biller, initiate the generation of a link token based on the request to link message, and transmit the link token to the specific biller. The at least one token processor is configured to generate a link token based on the request to link message, the link token defining a direct linkage between the biller and the specific consumer as defined by the request to link message and storing the link token in the database.

### BRIEF DESCRIPTION OF THE DRAWINGS

The drawings described below are for illustrative purposes only and are not necessarily drawn to scale. The drawings are not intended to limit the scope of the disclosure in any way. Wherever possible, the same or like reference numbers are used throughout the drawings to refer to the same or like parts.

FIG. 1 is a block diagram of a billing management system for the submission and retrieval of request for payment messages according to the embodiments disclosed herein.

FIG. 2 is a block diagram illustrating an exemplary database schema for the submission and retrieval of request for payment messages according to the embodiments disclosed herein.

FIG. 3 is a block diagram illustrating an exemplary linking process between a specific biller and a specific consumer to enable the submission of request for payment messages within the billing management system according to the embodiments disclosed herein.

FIG. 4 is a block diagram illustrating an exemplary retrieval of a request for payment invoice within the billing management system according to the embodiments disclosed herein.

FIG. 5 is a flow chart illustrating a method of an exemplary linking process between a biller and a consumer to enable the submission of request for payment messages within the billing management system according to the embodiments disclosed herein.

FIG. 6 is a flow chart illustrating an exemplary method for retrieving and processing a request for payment message within the billing management system according to the embodiments disclosed herein.

### DETAILED DESCRIPTION

As mentioned above, this application relates to a system and method for submission and retrieval of requests for payment messages and, more specifically, to the implementation of a bill payment exchange within a billing management system providing for the submission of requests for payment messages and retrieval of a previously submitted request for payment invoices across one or more issuer banks.

The disclosed embodiments provide a means for billers to submit request for payment messages to a centralized location and have each submitted request for payment message routed to the proper consumer, provided the biller and the consumer subscribe to a bill pay exchange computing system within a billing management system. After submitting request for payment messages, the subscribing consumer may retrieve any of the submitted request for payment invoices from the bill pay exchange computing through one or more issuer banks that also subscribe to the bill pay exchange computing system.

The technological improvements to the electronic bill management field resulting from the disclosed billing management system include at least providing a messaging gateway between one or more biller service providers and a plurality of commercial financial institutions; providing for the submission of request for payment messages addressed to multiple consumers to a centralized destination, routing of the submitted request for payment messages to the proper consumers, and retrieval of the request for payment invoices through one or more issuer banks; creation of a direct relationship between biller and consumer providing for enhanced security in the processing of RFP messages; increased user convenience in the retrieval of the request for payment invoices; enabling a consumer to efficiently remit a single request for payment invoice across multiple issuer banks; and consolidation of multiple request for payment invoices into a single location and with a standard interface.

At least some technical benefits are achieved due to the unique location of a bill pay exchange (BPX) computing system within the disclosed billing management system. Specifically, the placement of the BPX computing system enables it to leverage existing connections and infrastructure between biller service providers and commercial financial institutions to provide an additional channel to access and administers multiple request for payment invoices.

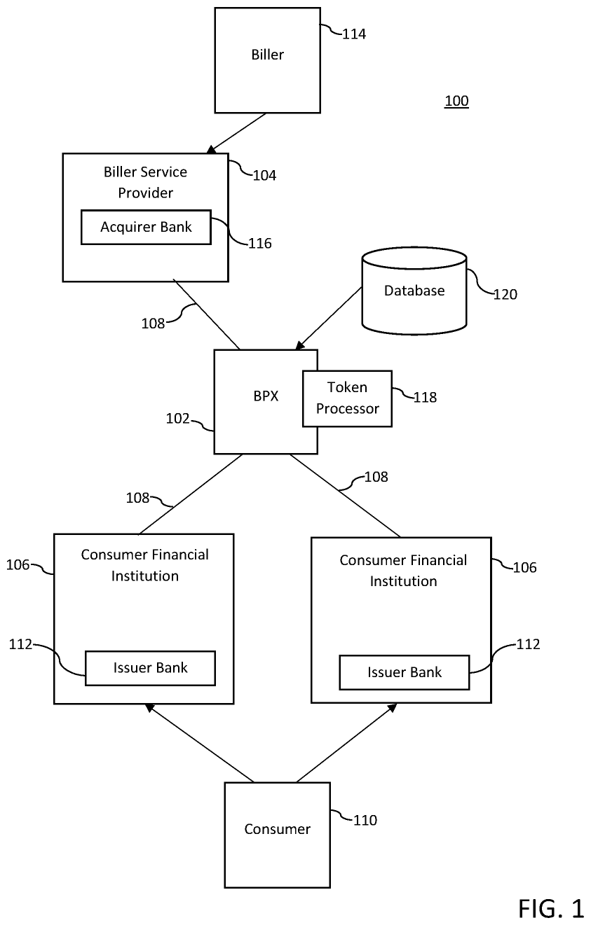

Turning to the figures, FIG. 1 is a block diagram of a billing management system 100 for the submission and retrieval of request for payment messages according to the embodiments disclosed herein.

As shown in FIG. 1, the billing management system 100 includes a bill pay exchange (BPX) computing system 102 that provides an electronic communications path 108 between one or more biller service providers 104 and a plurality of consumer financial institutions 106.

The plurality of consumer financial institutions 106 may provide a consumer 110 access to issuer banks 112 within the billing management system 100. Each consumer financial institution 106 may include an issuer bank 112 that issues and maintains a payment or bank account associated with the consumer 110. Alternatively, a consumer financial institution 106 may not include an issuer bank 112. The consumer financial institution 106 may simply provide access to a payment account on behalf of an issuer bank 112 independent of the consumer financial institution 106.

In either embodiment, the consumer financial institution 106 may provide a bill payment environment through which the consumer 110 may pay bills and conduct other financial processes such as viewing account balances and transferring funds between accounts.

A biller 114 represents any merchant to which the consumer 110 owes payment for services or products. For example, the biller 114 may include a merchant to which the consumer 110 owes a one-time payment, such as a retailer. Similarly, the biller 114 may include a merchant to which the consumer 110 owes a recurring payment, such as a mortgage or membership payment.

The biller service provider 104 may include an acquirer bank 116 that issues and maintains a bank account associated with a biller 114. Alternatively, a biller service provider 104 may not include an acquirer bank 116. Instead, the biller service provider 104 may simply provide access to a bank account on behalf of an acquirer bank 116.

In either embodiment, the biller service provider 104 may provide direct billing services for a biller 114 within the billing management system 100. Specifically, a biller service provider 104 may provide a bill payment environment associated with a specific biller 114, such as a website or software application that provides for payments directly to the specific biller 114 by the consumer 110 from within the billing management system 100. Moreover, the biller service provider 104 may interact with a payment monitoring system associated with the biller 114.

The BPX computing system 102 is configured to allow the one or more biller service providers 104 and the plurality of consumer financial institutions 106 to communicate through the BPX computing system 102 via the electronic communications path 108. In some embodiments, the BPX computing system 102 may function as a gateway in line with the electronic communications path 108, the electronic communications path 108 being comprised of any desired data network type, including the Internet. Various data network types may be implemented in accordance with the embodiments of the disclosed invention, including a wired or wireless local area network (LAN), a wide area network (WAN), and any other type of network that comprises or is connected to the Internet. When the electronic communications path 108 is implemented as a LAN environment, computing systems may be connected to the LAN through a network interface or adapter. When the electronic communications path 108 is implemented as a WAN network environment, computing devices may connect to the WAN through a modem, router, switch, or other data communication mechanism. The electronic communications path 108 may implement a data communication protocol that may include TCP/IP, UDP, OSI, Ethernet, or any other desired data communication protocol. Computing systems and devices connected to the electronic communications path 108 may communicate through a combination of wired and wireless paths.

The BPX computing system 102 may include any suitable processor-based computing devices, including one or more processor-based server computing devices and cloud-based computing and storage systems. The BPX computing system 102 may function to facilitate the submission and retrieval of request for payment messages originating from the biller 114. The request for payment messages may be transmitted to the BPX computing system 102 directly by the biller 114 or the biller service provider 104 over the electronic communications path 108. The BPX computing system 102 may be configured to function as a centralized messaging gateway between one or more billers 114 or corresponding biller service providers 104 and a plurality of consumer financial institutions 106 for submitting and retrieving requests for payment messages via the electronic communications path 108.

In some embodiments, the BPX computing system 102 may further include a token processor 118 that facilitates the generation of link tokens defining a direct relationship between a specific biller 114 and a specific consumer 110 within the billing management system 100.

The billing management system 100 may further include a database 120 in electronic communication with the BPX computing system 102. The database 120 provides the storage and searchable retrieval of data used to implement methods for submitting and retrieving request for payment messages via the electronic communications path 108. The database 120 may include a single database, a plurality of separate databases, or a combination of both. Moreover, the database 120 may be located at a single location or multiple locations. The database 120 is accessible to the BPX computing system 102 over any direct communications link, including a local area network (LAN) connection. The data stored on the database 120 may be used to implement the claimed method for the submission and retrieval of request for payment messages.

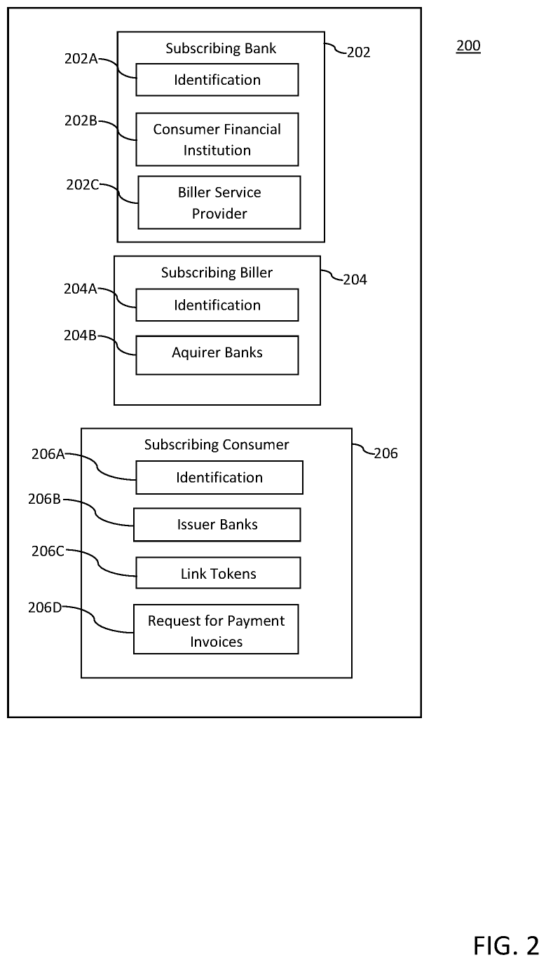

FIG. 2 is a block diagram illustrating exemplary database schema 200 for the submission and retrieval of request for payment messages according to the embodiments disclosed herein.

The database schema 200 may include a subscribing bank record 202 for each subscribing issuer bank 112 and acquirer bank 116 within the billing management system 100. The database schema 200 may further include a subscribing biller record 204 for each biller 116 and a subscribing consumer record 206 for each consumer 112 that subscribe to the billing management system 100.

Each subscribing bank record 202 may include an identification field 202A, a consumer financial institution field 202B, and a biller service provider field 202C. The identification field 202A may include information that enables the BPX computing system 102 to identify and certify each issuer bank 112 and each acquirer bank 116 within the billing management system 100. The consumer financial institution field 202B may include information on which consumer financial institution 106 may be associated with a corresponding issuer bank 112. The biller service provider field 202C may include information on which biller service provider 104 may be associated with a corresponding acquirer bank 116.

Each subscribing biller record 204 may include an identification field 204A and an acquirer bank field 204B. The identification field 204A may include information enabling BPX computing system 102 to identify and certify a subscribing biller 114 within the billing management system 100. The acquirer bank field 204B may include information on which subscribing acquirer banks 116 may be associated with a subscribing biller 114.

Each of the subscribing consumer records 206 may include an identification field 206A, an issuer banks field 206B, a link tokens field 206C, and a request for payment invoices field 206D.

The identification field 206A may include information that enables the BPX computing system 102 to identify and certify a subscribing consumer 110 within the billing management system 100. The identification information may include a unique consumer identifier for each subscribing consumer 110 that comprises alphanumeric characters, special characters, or any combinations thereof.

The issuer banks field 206B may include a listing of issuer banks 112 associated with a corresponding consumer 110. The listing of issuer banks 110 may further include a designation of a preferred issuer bank 110 for the corresponding consumer 110.

The link tokens field 206C may include a listing of link tokens for a corresponding subscribing consumer 110. Each link token is a unique identifier that defines a direct relationship between a specific biller 114 and a specific consumer 110 within the billing management system 100. The request for payment invoices field 206D may include a listing of request for payment invoices for a corresponding subscribing consumer 110. A specific biller 114 submits each request for payment invoice with a corresponding link token that defines a direct relationship between the specific biller 114 and the specific consumer 110 to whom the request for payment invoice is addressed.

A person of ordinary skill in the art will recognize that the same data may be organized using alternative database schemas while still remaining within the present disclosure. As an example, the subscribing banks and subscribing billers may be grouped together within the database in a manner that simply differentiates them from the subscribing consumers.

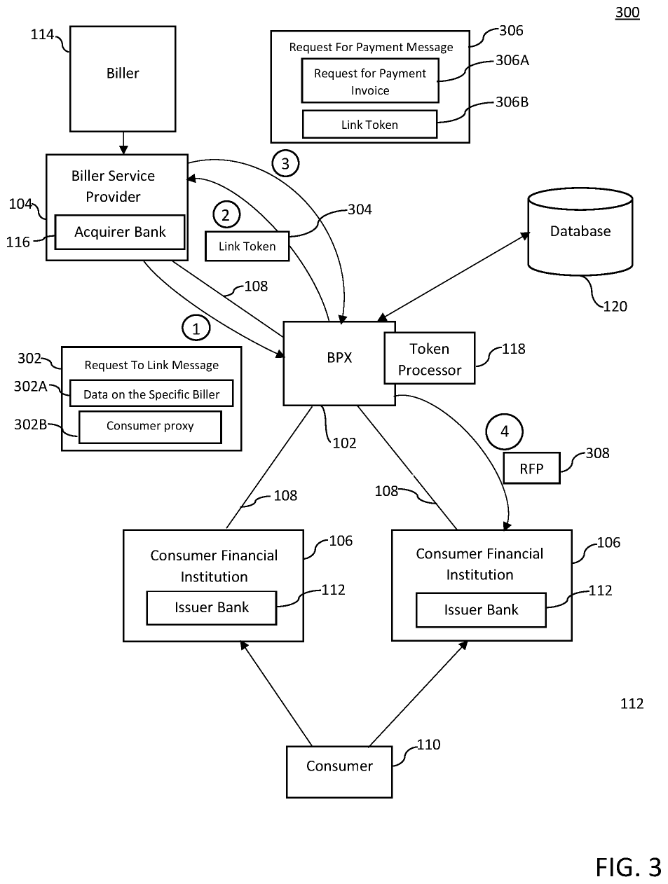

FIG. 3 is a block diagram 300 illustrating an exemplary linking process between a specific biller 114 and a specific consumer 110 to enable the submission of requests for payment messages within the billing management system 100 according to the embodiments disclosed herein.

The linking process between a subscribing biller 114 and a subscribing consumer 110 establishes an authenticated direct link between a specific biller 114 and a specific consumer 110 within the billing management system 100.

The linking process is initiated when the specific biller 114 transmits (1) a request to link message 302 to the BPX computing system 102. The request to link message 302 may be transmitted via the electronic communication path 108 by the biller service provider 104 associated with the specific biller 114. Alternatively, the specific biller 114 itself may transmit the request to link message 302 via the electronic communications path 108 to the specific consumer 110.

The request to link message 302 may include specific biller data 302A and a consumer proxy 302B. The specific biller data 302A may include a biller identifier, a biller service provider identifier, billing account information for the specific consumer, and any other relevant specific consumer and specific biller identification information.

The consumer proxy 302B is a secure means of identifying the specific consumer 110 within the billing management system 100. The consumer proxy 302B may be part of the identification field 206A within each of the subscribing consumer records 206 stored within the database 120. Each consumer proxy 302B is unique to a specific consumer 110 and is provided by each consumer 112. The consumer proxy 302B may contain alphanumeric characters, special characters, or any combination thereof. As an example, the consumer proxy 302B may be an email address, cellphone number, or national identification number.

Once the request to link message 302 has been received, the BPX computing system 102 validates the specific biller 114 and the specific consumer 110 identified in the request to link message 302. The specific biller 114 and its corresponding biller service provider 104 may be validated by the BPX computing system 102 using the specific biller data 302A included in the received request to link message 302. Specifically, the BPX computing system 102 may compare the specific biller data 302A with the information in the identification field 204A of each of the subscribing biller records 204 stored within the database 118.

Similarly, the specific consumer 110 may be validated by the BPX computing system 102 using the consumer proxy 302B included in the received request to link message 302. Specifically, the BPX computing system 102 may compare the consumer proxy 302B with the information in the identification field 206A of each of the subscribing consumer records 206 stored within the database 120.

Once the specific biller 114 and the specific consumer 110 have each been validated by the BPX computing system 102, a link token 304 is generated using the validated specific biller data 302A and consumer proxy 302B included within the received request to link message 302.

The link token 304 may be generated by the BPX computing system 102. Alternatively, the link token 304 may be explicitly generated by an independent token processor 118 within the BPX computing system 102.

The generated link token 304 may be a unique identifier defining a direct relationship between the specific biller 114 and the specific consumer 110 within the billing management system 100. The link token 304 includes tokenized data relevant to the direct relationship between the specific biller 114 and the specific consumer 110, including, at least, the data included within the validated request to link message 302. The link token 304 may contain any additional information known to a person of reasonable skill in the art that may further validate and secure the direct relationship between the specific biller 114 and specific consumer 110 within the billing management system 100.

The generated link token 304 is stored within the link tokens field 206C of the subscribing consumer record 206 for the specific consumer 112 within the database 118.

Once generated, the link token 304 is transmitted (2) via the electronic communications path 108 to the biller service provider 104 that originally transmitted the request to link message 302. Alternatively, the generated link token 304 may be transmitted directly to the specific biller 114 that originally transmitted the request to link message 302.

By generating and transmitting the link token 304, the billing management system 100 validates a direct relationship between a specific biller 114 or its corresponding biller service provider 104 and a specific consumer 110 or its corresponding consumer financial institution 106. This relationship within the billing management system 100 provides the consumer 110 with the flexibility to access, retrieve, and manage multiple request for payment invoices issued by one or more subscribing billers 116 from a centralized location.

Once a biller 114 or a corresponding biller service provider 104 has received a link token 304 for a specific consumer 110, the biller 114 may transmit (3) a request for payment message 306 to the BPX computing system 102 over the electronic communications path 108.

The request for payment message 306 may include a request for payment invoice 306A and a link token 306B. The request for payment invoice 306A is an invoice addressed to the specific consumer 110 that defines an amount due for services or products provided by the specific biller 114.

The link token 306B is a copy of a previously provided link token 304 generated and stored in the link tokens field 206C of the subscribing consumer record 206 within the database 120 for the specific consumer 110. Specifically, the link token 306B identifies a direct relationship between the specific biller 114 and the specific consumer 110, thereby validating the request for payment invoice 306A within the billing management system 100.

Once the request for payment message 306 has been received, the link token 306B is used to associate the request for payment invoice 306A to the specific consumer 110 within the database 120. This association may be done by storing the received request for payment invoice 306A in the request for payment invoices field 206D of the subscribing consumer record 206 for the specific consumer 110 within the database 120. A person of ordinary skill in the art will recognize other methods of association with the database may be implemented while remaining within the scope of the present disclosure.

After receiving the request for payment invoice 306A addressed to the specific consumer 110, the BPX computing system 102 determines if the specific consumer 110 has a preferred issuer bank 112. To make this determination, the BPX computing system 102 determines if one of the issuer banks listed in the issuer banks field 206B in the subscribing consumer record 206 for the specific consumer 110 has been designated as a preferred issuer bank 112.

If it is determined that the specific consumer 110 has a preferred issuer bank 112, the BPX computing system 102 transmits (4) a copy of the request for payment invoice 308 to the consumer financial institution 106 of the preferred issuer bank 112 over the electronic communications path 108. The BPX computing system 102 may determine the proper consumer financial institution 106 by looking at the consumer financial institution field 202B in the subscribing bank record 202 for the preferred issuer bank 110 within the database 120.

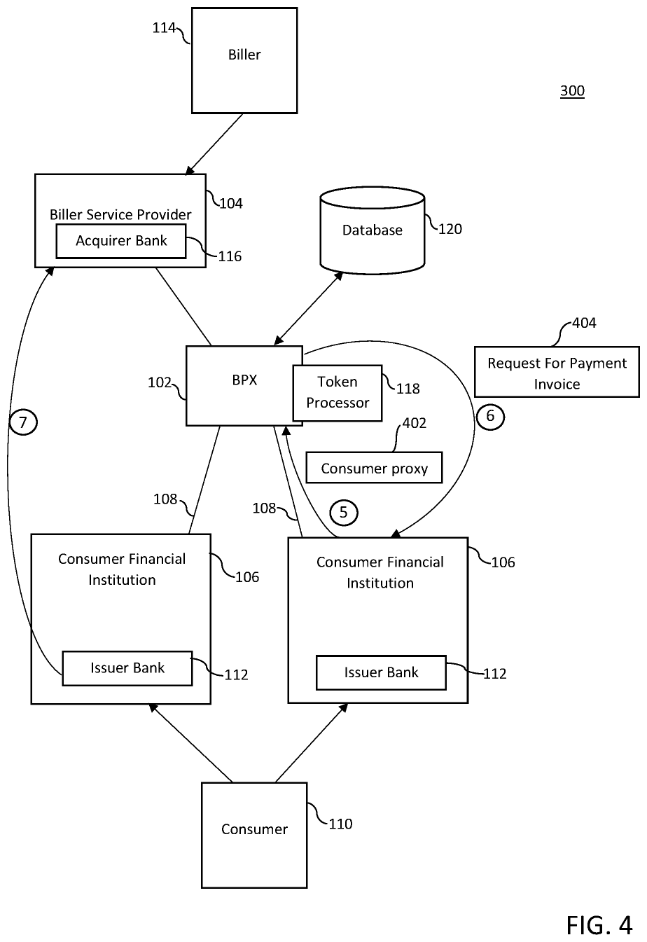

FIG. 4 is a block diagram 400 illustrating an exemplary retrieval of a request for payment invoice within the billing management system 100 according to the embodiments disclosed herein.

The retrieval of a request for payment invoice may be initiated by transmitting (5) the consumer proxy 402 of a specific consumer 110 to the BPX computing system 102 over the electronic communications path 108. The consumer proxy 402 may be transmitted directly by an issuer bank 112 for the specific consumer 110. Alternatively, the consumer proxy 402 may be transmitted by the consumer financial institution 106 associated with an issuer bank 112 for the specific consumer 110. Moreover, the consumer proxy 402 may be transmitted directly by the consumer 110.

The same consumer proxy 402 may be submitted to the BPX computing system 102 from multiple issuer banks 112 associated with the specific consumer 110. This type of submission allows the specific consumer 110 to effectively track the remittance of portions of a total payment of a request for payment invoice across multiple issuer banks 112. Similarly, the specific consumer 110 may track the remittance of the total payment of multiple request for payment invoices from multiple issuer banks 112.

Once the consumer proxy 402 has been received, the BPX computing system 102 uses the consumer proxy 402 to identify the specific consumer 110 based on the identification field 206A in each of the subscribing consumer records 206 within the database 120.

After the specific consumer 110 has been identified, the BPX computing system 102 confirms that the issuer bank 112 that transmitted the consumer proxy 402 is included in the issuer banks field 206B of the subscribing consumer record 206 for the specific consumer 110 within the database 118.

The BPX computing system 102 then identifies any link tokens 306B associated with the specific consumer 110 currently stored within the database 120. Specifically, the BPX computing system 102 identifies any link tokens 306B stored within the link tokens field 206C in the subscribing consumer record 206 for the specific consumer 110 within the database 120.

For any identified link tokens 306B, the BPX computing system 102 retrieves the request for payment invoice 306A linked with each of these link tokens 306B within the database 120. The request for payment invoice 306A may be retrieved from the request for payment invoices field 206D in the subscribing consumer record 206 for the specific consumer 110. A person of ordinary skill in the art will recognize that other methods of storing payment invoices within the database may be implemented, providing for retrieval of requests for payment invoices linked to specific link tokens while still remaining within the scope of the present disclosure.

Alternatively, the BPX computing system 102 may retrieve all the request for payment invoices 306A currently stored in the subscribing consumer record 206 for the specific consumer 110 with the database 120.

Any retrieved request for payment invoices 404 are then transmitted (6) via the electronic communications path 108 to the specific issuer bank 112 that originally transmitted (5) the consumer proxy 402 to the BPX computing system 102.

Once received at an issuer bank 112, each request for payment invoice 404 may be processed (7) between one or more of the consumer financial institutions 106 and a biller service provider 104 to remit funds from one or more issuer banks 110. This process may be implemented over any payment processing network known to one of ordinary skill in the art outside of the electronic communications path 108.

As mentioned above, several issuer banks 112 may receive the same request for payment invoices 404 from the BPX computing system 102 via the electronic communications path 108. As a result, the consumer 110 may source portions of a total payment for a single request for payment invoice 404 to an acquirer bank 116 from multiple issuer banks 112. Similarly, the consumer 110 may source a total payment for several different request for payment invoices 404 to an acquirer bank 116 from multiple issuer banks 112.

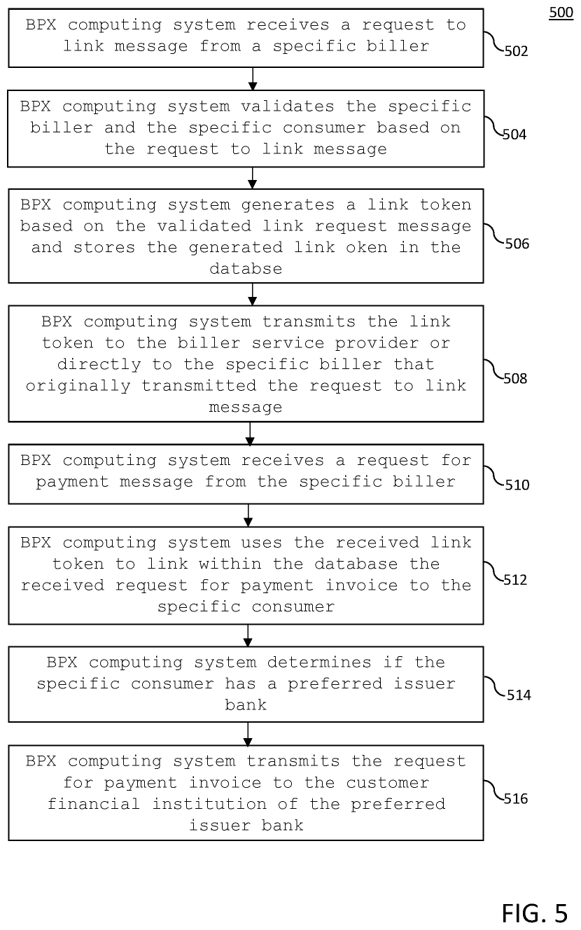

FIG. 5 is a flow chart illustrating a method 500 for an exemplary linking process between a specific biller 114 and a specific consumer 110 to enable the submission of requests for payment messages 306 within the billing management system 100 according to the embodiments disclosed herein.

As shown in FIG. 5, the method 500 begins in step 502 with the BPX computing system 102 receiving a request to link message 302 via the electronic communications path 108 from a specific biller 114. The request to link message 302 includes specific biller data 302A and a consumer proxy 302B.

Next, in step 504, the BPX computing system 102 validates the specific biller 114 and the specific consumer 110 based on the request to link message 302. Specifically, the specific biller 114 is validated by comparing the specific biller data 302A to the identification field 204A of each of the subscribing biller records 204 within the database 120.

Similarly, the specific consumer 110 is validated by comparing the consumer proxy 302B with the identification field 206A in each of the subscribing consumer records 206 within the database 120.

Next, in step 506, the BPX computing system 102 generates a link token 304 based on the validated request to link message 302 and stores the generated link token 304 in the link token field 206C of the subscribing consumer record 206 for the specific consumer 112 within the database 118.

Next, in step 508, the BPX computing system 102 transmits the generated link token 304 via the electronic communications path 108 to the biller service provider 104 or directly to the specific biller 114 that originally transmitted the request to link message 302.

Next, in step 510, the BPX computing system 102 receives a request for payment message 306 via the electronic communications path 108 from a specific biller 114. The request for payment message 306 includes a request for payment invoice 306A and a link token 306B.

Next, in step 512, the BPX computing system 102 uses the received link token 306B to associate the received request for payment invoice 306A to the specific consumer 110 within the database 120. This association may be done by storing a copy of the request for payment invoice 306A in the request for payment invoices field 206D in the subscribing consumer record 206 for the specific consumer 110 with the database 120. Alternatively, this association may be done by storing an identifier within an originally stored link token 304 that identifies each request for payment invoice 306A associated with that link token 304.

Next, in step 514, the BPX computing system 102 determines if the specific consumer 110 has a preferred issuer bank 112. This determination may be made by examining the issuer banks field 206B within the subscribing consumer record 206 for the specific consumer 110 with the database 120.

Lastly, in step 516, the BPX computing system 102 transmits the request for payment invoice 306A to the consumer financial institution 106 of the preferred issuer bank 112 via the electronic communications path 108.

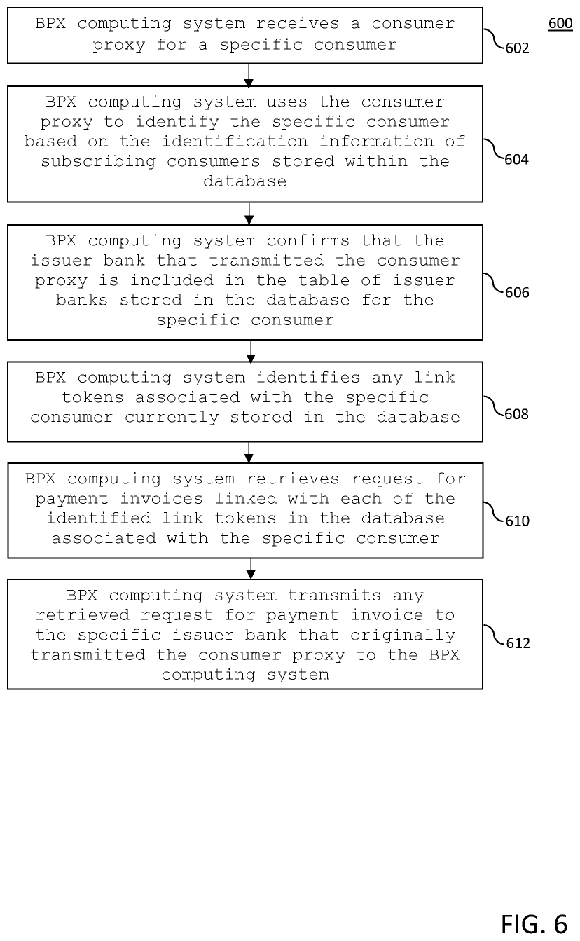

FIG. 6 is a flow chart diagram illustrating a method 600 for an exemplary retrieval of request for payment messages 306 within the billing management system 100 according to the embodiments disclosed herein.

As shown in FIG. 6, the method 600 begins in step 602 with the BPX computing system 102 receiving a consumer proxy 404 for a specific consumer 112 via the electronic communications path 108. The consumer proxy 404 may have been transmitted directly by an issuer bank 112. Alternatively, the consumer proxy 404 may have been transmitted by the consumer financial institution 106 associated with an issuer bank 112.

Next, in step 604, the BPX computing system 102 uses the consumer proxy 404 to validate the specific consumer 110 based on the identification field 206A in each of the subscribing consumer records 206 within the database 120.

Next, in step 606, the BPX computing system 102 confirms that the issuer bank 112 that transmitted the consumer proxy 302B is included in the issuer banks field 206B of the subscribing consumer record 206 for the specific consumer 110 within the database 120.

Next, in step 608, the BPX computing system 102 identifies any link tokens 306B associated with the specific consumer 112 currently stored in the database 118.

Specifically, the BPX computing system 102 retrieves the link tokens 306B stored in the link tokens field 206C of the subscribing consumer record 206 for the specific consumer 110 within the database 120.

Next, in step 610, the BPX computing system 102 retrieves the request for payment invoice 306A associated with each of the link tokens 306B identified associated with the specific consumer 110 within the database 108.

Lastly, in step 612, the BPX computing system 102 transmits any retrieved request for payment invoices 402 via the electronic communications path 108 to the specific issuer bank 112 that originally transmitted the consumer proxy 404 to the BPX computing system 102.

The foregoing description discloses only example embodiments. Modifications of the above-disclosed assemblies and methods which fall within the scope of this disclosure will be readily apparent to those of ordinary skill in the art.

This disclosure is not intended to limit the invention to the assemblies and/or methods disclosed, but, to the contrary, the intention is to cover all modifications, equivalents, and alternatives falling within the scope of the claims.

What is claimed is:

1. A billing management system providing for submission and processing of request for payment messages, comprising:
a bill pay exchange (BPX) computing system comprising at least one processor;
a database storing data on consumers and billers subscribing to the BPX computing system, the database in electronic communication with the BPX computing system;
one or more biller service providers, each of the biller service providers associated with one or more of the billers;
a plurality of commercial financial institutions, each of the commercial financial institutions associated with one or more of the consumers;
the BPX computing system proving an electronic communications path between the one or more biller service providers and the plurality of commercial financial institutions;
the BPX computing system configured to:
receive a request to link message from a specific biller, the request to link message including a consumer proxy identifying a specific consumer and specific biller data;
confirm the identity of the specific biller based on the data on the specific biller;
confirm the identity of the specific consumer based on the consumer proxy;
generate a link token based on the request to link message, the link token defining a direct linkage between the biller and the specific consumer as defined by the request to link message;
store the link token in the database; and
transmit the link token to the specific biller.

2. The billing management system of claim 1, wherein the specific biller data includes a biller identifier, a biller service provider identifier, and billing account information on the specific consumer.

3. The billing management system of claim 1, wherein the BPX computing system is further configured to:
receive a request for payment message from the biller, the request for payment message including a request for payment invoice directed to the specific consumer and the link token;
validate the direct linkage between the specific biller and the specific consumer within the database based on the link token;
retrieve a preferred issuer bank from the database for the specific consumer; and
transmit the request for payment invoice to a specific commercial financial institution associated with the preferred issuer bank.

4. The billing management system of claim 2,
wherein the database includes:
subscribing bank fields, each of the subscribing bank fields comprised of an identification record and a commercial financial institution record;
subscribing biller fields, each of the subscribing biller fields comprised of an identification record and a biller service provider record; and
subscribing consumer fields, each of the subscribing consumer fields comprised of an identification record, a table of issuer banks record, a link token record, and a request for payment invoices record; and
wherein the computing system is further configured to:
receive the consumer proxy from an issuer bank;
identify the specific consumer within the database associated with the consumer proxy using the identification record in each of the subscribing consumer fields;
confirm that the issuer bank is associated with the specific consumer using the table of issuer banks record in the subscribing consumer field for the identified specific consumer;
identify from within the database any link tokens associated with the specific consumer using the link token record in the subscribing field for the specific consumer;
retrieve from within the database any pending requests for payment invoices associated with the identified link tokens using the request for payment invoices record in the subscribing consumer field for the specific consumer; and
transmit any requests for payment invoices retrieved from the database to the issuer bank.

5. A billing management system providing for submission and processing of request for payment messages, comprising:
a bill pay exchange (BPX) computing system comprising at least one processor and at least one token processor;
a database storing and retrieving data on consumers and data on billers subscribing to the billing management system, the database in electronic communication with the BPX computing system;
one or more biller service providers, each of the biller service providers associated with one or more of the billers;
a plurality of commercial financial institutions, each of the commercial financial institutions associated with one or more of the consumers; and
the BPX computing system providing an electronic communications path between the one or more biller service providers and the plurality of commercial financial institutions;
the BPX computing system is configured to:
receive a request to link message from a specific biller, the request to link message including a consumer proxy identifying a specific consumer and data on the specific biller;
initiate the generation of a link token based on the request to link message; and
transmit the link token to the biller;
the at least one token processor configured to:
generate a link token based on the request to link message, the link token defining a direct linkage between the specific biller and the specific consumer as defined by the request to link message; and
store the link token in the database.

6. The billing management system of claim 5, wherein the data on the specific biller includes a biller identifier, a biller service provider identifier, and billing account information on the specific consumer.
